(19) United States
(12) Patent Application Publication
(10) Pub. No.: US 2004/0188232 A1
(43) Pub. Date: Sep. 30, 2004

(54) Thread detector

(76) Inventors: Birger Johansson, Ulricehamn (SE); Paer Josefsson, Boras (SE)

Correspondence Address: Flynn Thiel, Boutell & Tanis, 2026 Rambling Road, Kalamazoo, MI, 49008-1631, US

(21) Appl. No.: 10/474,866

(22) PCT Filed: Apr. 3, 2002
(86) PCT No.: PCT/EP02/03692

(30) Foreign Application Priority Data
Apr. 10, 2001 (DE) 101 17 879.4

(51) Int. Cl. H01H 9/00

(52) U.S. Cl. 200/61.18

(57) ABSTRACT

The invention relates to a thread detector (F) for detecting thread path/halt conditions and/or thread tension. Said detector is provided with a deflector assembly for re-directing the thread, said assembly transmitting the stress on the thread to at least one transducer device (W), which generates a signal and responds to mechanically transmitted stresses. The deflector is also provided with at least one electronic evaluation circuit (6) for deriving output signals, (i1, i2) and with thread guides (8), which are located upstream and downstream of the deflector assembly and define the course of the thread. The deflector assembly comprises a first and second deflector (D1, D2) that lie one behind the other in the course of the thread, one of Which transmits the stress from the thread tension and the other the stress from the path/halt conditions to a respective transducer device (W). The deflectors having first and second re-direction surfaces (9, 10), positioned transversely in relation to the thread axis, which together form an angle of <180°, (when viewed from the thread axis), whereby said re-direction surface share the deflection of the thread.

### FIELD OF THE INVENTION

The invention relates to a thread detector for detecting a thread condition.

### BACKGROUND OF THE INVENTION

Such a thread detector e.g. is used in the thread path between a weft thread feeding device and the weaving shed of a weaving machine. Information on the momentary thread tension of the stopped or running thread is used to control several different operations, in addition to information of thread running/stopping conditions provided by a separate weft thread monitor.

It is known from DE 43 23 748 A (U.S. Pat. No. 5,476,122) to carry out both functions by a single thread detector. The thread actuates via a single deflector a piezo-element which is connected for signal transmission to a control unit. By means of the permanently measured thread tension e.g. the braking force of a weft thread brake is adapted to the weft thread insertion conditions. From a strong drop in the thread tension the conclusion of a weft thread breakage (weft thread monitor function) is derived.

In a weft thread detector known from DE 31 10 462 A (U.S. Pat. No. 4,381,803) as used for the weft thread monitor function additionally also the thread tension is scanned. Both functions are carried out by means of a single deflector and a single converting component e.g. of a piezo-electrical kind.

A similar weft thread monitor for both functions also is known from U.S. Pat. No. 4,228,828 A.

In a thread detector known from EP 03 57 975 A (U.S. Pat. No. 5,050,648) a single sensor of a weft thread monitor actuated by a deflector simultaneously is used as a thread tension sensor in order to control a thread brake.

Further prior art related to measuring thread tension is contained in EP 06 05 550 A (U.S. Pat. No. 5,462,094), EP 05 74 062 A, U.S. Pat. No. 3,300,161 A, WO 97/13131.

Clear and useful output signals for both functions (thread tension measurement and scanning of thread running/stopping conditions) can only be gained from a single deflector by employing relatively fine electronic equipment contributing to high costs of the thread detector and also contributing to sensitivity for failures, because the prerequisites for monitoring the thread running/stopping conditions are completely different from the prerequisites for measuring the thread tension.

It is an object of the invention to provide a thread detector of the kind as disclosed at the beginning which is capable of collecting information in another way and with better adaptation to the respective prerequisites, which derives the information with low mechanical load for the thread, which is to manufacture for fair costs and with reliable operation behaviour, and which is capable of covering a broad range of applications (for differently operating yarn processing systems or weaving machines and feeding devices and for all thread qualities processed in practice).

Each deflector optimally scans the thread in view to the special prerequisite and for the task associated to the respective deflector (measurement of the thread tension or/and running/stopping conditions). Already for this reason each deflector may co-operate with a relatively simple conversion assembly customised for the respective function. In case of a failure of one function the other function is maintained without being influenced. As both detectors share the thread detection among themselves and perform as a single form fit thread guide or even as a two-dimensional thread guide, the mechanical load remains moderate for the thread and a total deflection suffices which is significantly less than the sum of the deflections normally occurring in two completely separated devices each provided for one respective function. Due to the angle formed between the deflection surfaces of less than 180° each deflection surface derives a force component powerfully pressing the thread against the respective other deflecting surface. The force component directly is derived from the thread load despite the small deflection angle. By this the response sensitivity is improved without excessively loading the thread. Due to the selected geometry each deflector consumes only as much of the total thread load as is expedient for its associated function.

Both deflectors, expediently, are directly and without contact next to each other in the thread path such that the force generated from the thread load at at least one deflection surface becomes active as directly as possible at the deflection surface of the other deflector. Furthermore, the close positioning of the deflectors has the advantage that they act commonly like a single two-dimensional thread guide in order effectively stabilise the running thread. This is of advantage for the preciseness of the detection.

The angle between the deflection surfaces at least should be substantially 90°. In this case a positive guiding effect of the running thread is ensured.

In case that at least the deflection surface of one deflector is offset crosswise to the thread axis in relation to a stretched thread path and in the direction of the orientation of the deflection surface of the respective other deflector, the amount of the offset will determine the deflection of the thread in the thread detector. Expediently, the deflection surfaces of both deflectors are positioned with a crosswise offset relative to the stretched thread path such that the thread imparts predetermined loads on both deflections surfaces as needed for the respective and reliable detection.

Of particular importance is an inclination position angle of at least the deflection surface of one deflector in relation to a plane defined by the fictive straight thread path and the actual thread path. The inclined position is adjusted such that a sliding force component directed to the deflection surface of the other deflector is generated from the thread load at the inclined deflection surface. As a result, the deflection surface of the other deflector is actuated not only by the reaction force of the deflection of the thread, which may be small at this location, but additionally also by the sliding force component. Such arrangement allows to provide a relatively small total deflection angle for the thread which small total deflection angle contributes to prevent damage to the thread.

An angle of the inclined position of about 70° in relation to the mentioned plane is of expedience for the one deflection surface. In case of a 90° crossing of both deflectors the angle of the inclined position of the other deflector in relation to the same plane will amount to about 20°. Both angles may be varied. Expediently the deflector defining by its deflection surface the angle of about 70° of the inclined position with the mentioned plane is used for measuring the thread tension. This is because the thread tension is determined more precisely if the thread imparts a considerable part of the load onto this deflector which load results from the thread tension. For monitoring the thread running/stopping conditions it is sufficient to provide a smaller angle of the inclined position for the other deflector, because information of the running/stopping conditions are detected predominantly by means of friction loads and vibration loads. To clearly measure friction loads and vibration loads the contact pressure of the thread may be lower or oriented differently than for measuring the thread tension.

For a simple manufacture, high reliability of operation and for practically all thread qualities deflectors may be used which are shaped like rods or tubes. Identical outer diameters of the deflectors may be expedient but are not necessary in every case. Ceramic material offers the advantage of high wear resistance and a certain intrinsic damping function combined with low weight.

The separately operating deflectors are provided at a respective converter element each of which is supported stationarily. Expediently, the deflectors are secured by foot portions at the converter elements such that the loads imparted by the thread are transmitted via large lever arms and without a falsifying influence. Of particular expedience are converter elements of piezo-electric or photo-elastic kinds, because those types of converter elements are capable to output clear and useful signals with moderate control efforts only. Alternatively, inductive, tribo-electric or other converter elements could be employed, or even strain gauge strips directly fixed at the deflectors.

In case that each piezo-electric converter element is integrated into a film chip already containing at least a part of the evaluation circuitry, the structural effort may be kept low.

A photo-elastic converter element penetrated by light varies its optical properties in dependence from the deformation or its internal tension condition, respectively. The intensity of the exiting light varies within a broad range and delivers clear signals which can be detected in an opto-electronical way and can be evaluated.

Expediently, the photo-elastic converter element is constituted by a plate made of a transparent plastic like polycarbonate (or an optical glass). The plate is fixed at at least one side, preferably at both ends, and is actuated by the deflector almost exclusively for torsion. The mentioned material is practically isotropic when free of internal stress and changes towards anisotropic upon increasing internal tension, e.g. in case of a torsional tension. The opto-electonical detecting assembly follows the variation of the optical behaviour and outputs a signal which e.g. is representative for the thread tension. This can be made without significant efforts in terms of amplification or conditioning. In this case the optical axis of the detection assembly should penetrate the plate perpendicular to the surfaces of the plate.

The photo-elastic element may be penetrated by isochromatic light, e.g. red light emitted by a LED. At the light entrance side and at the light exit side polarising elements are employed, the polarisation axes of which cross each other, in order to adjust a positioning such that almost no light exits when the element is free of load, while the intensity of the exiting light increases with increasing internal tension according to a function which even may be linearised by a technically simple control equipment. The variation of the intensity of the exiting light e.g. can be scanned by means of a photo transistor.

A structurally simple embodiment of the thread detector has a base body containing a support for the converter assemblies, the deflectors and the yarn guides. The deflectors ought to spatially cross each other without contact. The support, expediently, has an inclined position about the thread axis such that from the load on the thread on the at least one detector an enforced thread contact pressure is generated on the deflection surface of the other deflector, such that the response behaviour of the thread detector is improved and such that totally a relatively small deflection angle may be selected in the thread detector.

The support, expediently, even is adjustable in order to allow to adapt the thread detector to the respective operation conditions or thread qualities, respectively.

### BRIEF DESCRIPTION OF THE DRAWINGS

Embodiments of the subject invention will be explained with the help of the drawings in which:

FIG. 1 is a perspective view of a thread detector,

FIGS. 2, 3 and 4 are schematic views of detail variations of the thread detector of FIG. 1, and

FIG. 5 is a further detail variation in perspective schematic view.

### DETAILED DESCRIPTION

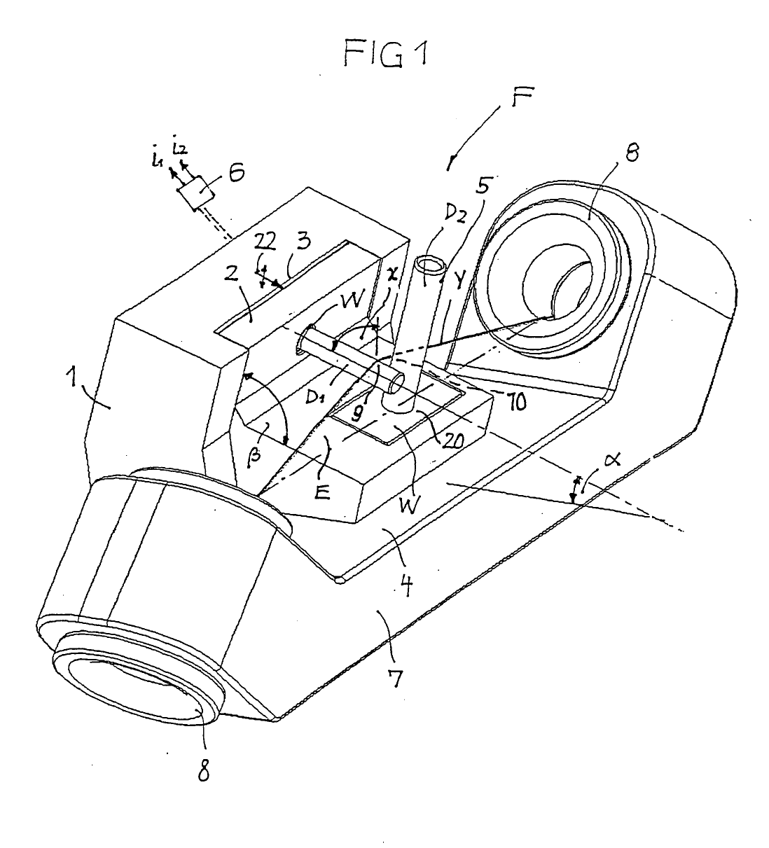

A thread detector F shown in FIG. 1 is intended for use in thread processing systems, e.g. for use in the thread path between a weft thread feeding device and a weaving machine. By the thread detector F of this embodiment selectively the thread tension can be measured and/or the thread running/stopping condition of the weft thread can be monitored. Each function is carried out independently. If needed, one of both functions may be disabled without influencing the other remaining function. Of course, both functions permanently and commonly can be carried out.

The thread detector F is in FIG. 1 has a base body 1 in which a support 2 for two converter assemblies W is mounted in respectively shaped sockets 3. A bridge-like holder 7 supports two yarn guides 8 defining a fictive straight thread path through the thread detector F. A surface 4 of the holder 7 for explanation purposes defines a horizontal reference plane.

A converter element 20 is stationarily supported in each converter assembly W. The converter element 20 e.g. may be piezo-electric converter element or a photo-elastic converter element. First and second deflectors D1 and D2 are provided at the converter elements 20 in freely cantilevering fashion, e.g. each having the shape of a round rod or a round tube 5, e.g. made of ceramic material. The converter elements 20 are connected to an electronic evaluation circuitry 6 emitting exit signals i1, i2. The evaluation circuitry may be provided in the base body 1. It may be expedient to integrate each converter element 20 into a film chip already containing at least a part of the evaluation circuitry. Both deflectors D1, D2 are arranged along the thread path directly behind each other without contacting each other. Each deflector D1, D2 forms one deflection surface 9, 10 for the thread Y while the thread Y is supported by the thread guides 8. The deflection surfaces 9, 10 define an angle β with each other which angle is set by means of the support 2, e.g. an angle of about 90°. Between both yarn guides the thread Y is deflected at both deflecting surfaces 9, 10.

The actual deflected thread path shown by a full line and the fictive stretched thread path indicated in a chain dotted line commonly define a plane E. At least the deflection surface 9 which is oriented crosswise to the axis of the thread is inclined under an inclination position angle X in relation to plane E. This relationship also is indicated by the angle α between the axis of the deflector D1 and the surface 4. The second deflector D2 may be oriented perpendicularly with respect to the plane defined by the surface 4, or may be, as shown, inclined also by the support 2 in FIG. 1 to the right side and upwardly under a crossing angle β of about 90° with respect to the first deflector D1. The inclined position angle X e.g. may be varied upon demand at the support 2 by an adjustment device 22 provided in the base body 1.

The deflector D1 having the converter element W expediently serves for measuring the tension of the thread. To the contrary, the deflector D2 serves for monitoring of thread running/stop conditions. The first and second deflection surfaces 9, 10 share the total deflection of the thread among themselves. For the measurement of the tension of the thread the deflection surface 9 may be loaded by the thread Y more strongly than the deflection surface 10 is loaded by the same thread Y.

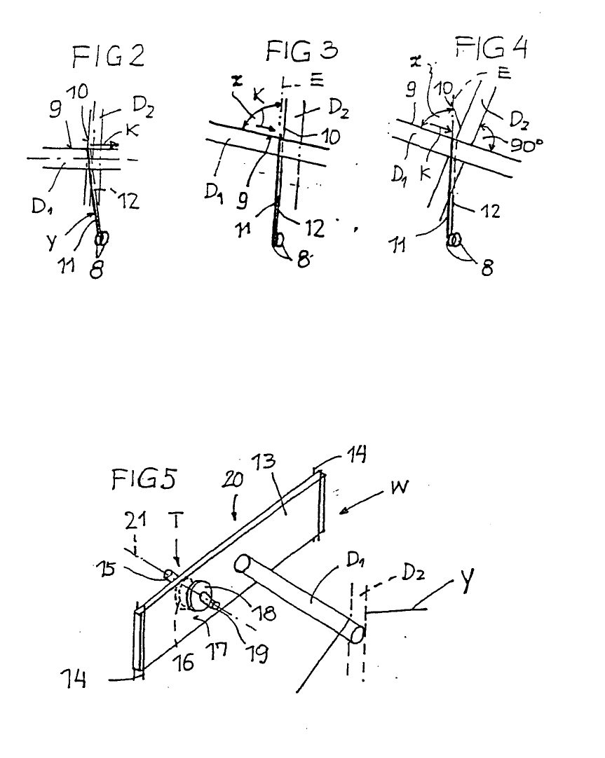

FIGS. 2 to 4 indicate different detail variants of the relative positioning of the first and second deflectors D1, D2 in relation to the yarn guides 8.

The first and second deflection surfaces 9, 10 provided at both deflectors D1, D2 in FIG. 2 are positioned with an offset in relation to the fictive stretched thread path defined by the thread guides 8, such that the thread is guided in the angle shaped knee region defined between both deflection surface 9, 10 and is deflected at the both deflection surfaces 9, 10 such that the thread develops a sliding force component K from its load at the deflectors D1, D2 which slide force component K at least is directed in the direction of the orientation of the first deflection surface 9 and against the other deflection surface 10. The slide force component K, thus developed, increases the otherwise lower contact pressure of the thread at the other deflection surface 10. A section 11 of the thread Y extending to the first deflection surface 9 runs in FIG. 2 upwardly and slightly to the left side, is then deflected at the first deflection surface 9, and changes over onto the second deflection surface 10. The thread Y then is deflected by the second deflection surface 10 and additionally is pressed against the deflection surface 10 with the slide force component K. A section 12 of the thread further extends to the other thread guide 8.

In FIG. 3 the second deflection surface 10 is provided in vertical alignment to the stretched thread path defined by the thread guides 8. The first deflection surface 9 is tilted to the right side with the inclined position angle X relative to the plane E, such that the incoming and deflected section 11 of the thread Y develops a sliding force component K from the load at the first deflection surface 9 which slide force component K is directed to the right side and such that the thread additionally is pressed against the second deflection surface 10.

In FIG. 4 both deflectors D1, D2 are arranged in relation to each other with a crossing angle of about 90°. The first deflector D1 is inclined to the right side with an inclined position angle X (e.g. 70°) in relation to the plane E, such that the incoming section 11 of the thread Y develops a sliding force component K at the first deflection surface 9, which sliding force component K is directed to the right side and towards the second deflection surface 10 and which slide force component K presses the outgoing section 12 of the thread more intensively against the second deflection surface 10. Furthermore, the outgoing section 12 of the thread is deflected also by the inclined position of the second deflector D2 at the second deflector D2.

FIG. 5 shows a photo-elastic converter element 20 employed as the converter assembly W e.g. of the deflector D1. The converter element 20 has the shape of a thin longitudinal plate 13 and consists of a photo-elastic material, e.g. plastic material or optical glass, respectively, which is substantially isotropic in a tension free condition. In case that the interior tension increases this material changes its optical properties, e.g. in a direction towards anisotropic. This change can be converted into a clear output signal when the converting element 20 is penetrated by light, e.g. by isochromatic light. In this case the intensity of the exiting light is varying and can be scanned in order to make a conclusion first to the tension condition of the converter element 20 and indirectly to the tension in the thread.

The plate 13 e.g. is supported stationarily at both ends at 14. The deflector D1 is secured at the plate 13 in a freely cantilevering fashion such that the load exerted by the thread Y on the deflector D1 produces pure torsion in the plate 13, i.e., interior torsion stresses. An opto-electronic scanning device T is provided between the fixation of the deflector D1 and a tension portion 14. The scanning device T1 scans the change of the optical property of the plate 13 when light penetrates the plate (or by reflection). The opto-electronic scanning device T has an optical axis 21 which penetrates the plate 13 substantially perpendicular to the plate surfaces 17. At one side of the plate 13 and situated in the optical axis 21 a light source 15 is placed e.g. a red light LED, emitting, e.g., substantially quasi-isochromatic light.

A first polarising element 16 having a linear polarisation axis with a given direction is placed in front of the surface 17 of the plate 13. A second polarisation element 18 is placed close to the opposite surface 17 of the plate 13, such that a given linear polarisation axis of the second polarisation element 18 crosses the polarisation axis of the first polarisation element 16. A receiver 19 is placed in the light path behind the second potarisation element 18, e.g. a photo-transistor. The relative positions between the polarisation elements 16, 18 optionally even in relation to the optical light penetration axis of the plate 13 are adjusted, e.g. such that no light will exit from the plate 13 when the plate 13 is in a stress free condition, e.g. because the light waves extinguish themselves, e.g. due to the double fraction effect of the polarisation elements.

As soon as the interior torsion stress in the plate 13 increases, caused by the load of the thread Y on the deflector D1, the intensity of the exiting light increases according to a mathematical function, e.g. with a function of the square of the torque exerted by the deflector D1. The receiver 19 responds to the increase of the intensity of the light. By comparison of the received light with the emitted light, or even in a direct fashion, an output signal, e.g. i1, is emitted which is representative for the momentary tension in the thread.

In the described embodiments, both deflectors D1, D2 are formed with deflection surfaces which extend straight in a direction crosswise to the axis of the thread. However, the deflection surfaces instead could be formed with concave or convex curvatures, respectively. Furthermore, both deflectors D1, D2 do not need to be positioned very close to each other. A small intermediate distance might exist, or to the contrary, even a spatial overlap between both deflectors may set, e.g. by providing corresponding cut-outs in the then interengaging deflectors, such that both deflection surfaces 9, 10 of the deflectors even can be put closer to each other than shown. Furthermore, the angle included between both deflection surfaces 9, 10 even could be significantly smaller or larger than 90°, however, not larger than 180°. A total deflection angle of ±15° for the thread is sufficient for almost all thread qualities for precisely measuring the tension of the thread and monitoring the thread running/stop conditions. Each of both functions separately can be switched in or switched off. A failure of one function does not influence the other function.

Although a particular preferred embodiment of the invention has been disclosed in detail for illustrative purposes, it will be recognized that variations or modifications of the disclosed apparatus, including the rearrangement of parts, lie within the scope of the present invention.

1. Thread detector for detecting thread running/stop conditions and/or the tension in the thread, comprising a deflector assembly for deflecting the thread, at least one signal generating converter assembly mechanically actuated by the deflector assembly and responding to loads exerted by the thread or the deflector assembly, at least one electronic evaluation circuitry (6) for deriving output signals (i1, i2), and stationary thread guides (8) arranged upstream and downstream of the deflector assembly, for defining a thread path through the thread detector, characterised in that wherein the deflector assembly includes a first deflector (D1) and a second deflector (D2) arranged in the thread path one behind the other, that a respective converting assembly (W) is associated to each deflector, that the first and second deflectors (D1, D2) comprise first and second deflection surfaces (9, 10) each oriented crosswise to the axis of the thread, and that the deflection surfaces (9, 10) include an angle (β) smaller than 180° with each other seen in the direction of the axis of the thread, and share the total thread deflection among each other.

2. Thread detector as in claim 1, characterised in that wherein the first and second deflectors (D1, D2) are placed closely adjacent and without contact in the thread path.

3. Thread detector as in claim 1, characterised in that wherein the angle (β) at least amounts to about 90°.

4. Thread detector as in claim 1, characterised in that wherein the deflection surfaces (9, 10) are offset with respect to a fictive stretched thread path defined by the thread guides (8) respectively in the direction of the orientation of the respective other deflection surface and crosswise to the axis of the thread.

5. Thread detector as in claim 1, characterised in that wherein the fictive stretched thread path defined by the thread guides (8) and the actual thread path deflected over the deflectors (D1, D2) commonly define a plane (E), and that at least the deflection surface (9) of one of the deflectors (D1) is provided with an inclination position angle (X) inclined by its orientation crosswise to the axis of the thread in and relation to the plane (E) such that the thread load exerted at this deflection surface (9) generates a sliding force component (K) in the thread which sliding force component (K) is directed against the deflection surface (10) of the other deflector (D2).

6. Thread detector as in claim 5, characterised in that wherein the inclined position angle (X) of the deflector (D1) amounts to about 70°, and that, preferably, the other deflector (D2) deflection surface (10) includes an inclined position angle of about 20° with the plane (E).

7. Thread detector as in claim 1, characterised in that wherein both deflectors (D1, D2) are round rods or tubes (5) having substantially equal outer diameters, that the rods or tubes (5) are supported at one end respectively, and that rods or tubes (5), preferably, consist of ceramic material.

8. Thread detector as in claim 1, characterised in that wherein each deflector (D1, D2) is arranged at a stationarily provided converter element (20) of its converter assembly (W).

9. Thread detector as in claim 8, characterised by wherein the converter element comprises a piezo-electric or photo-elastic converter element (20).

10. Thread detector as in claim 1claim 8, characterised in that wherein the piezo-electric converter element (20) is integrated into a film chip.

11. Thread detector as in claim 9, characterised in that wherein the photo-elastic converter element (20) is formed with a plate-shape from a transparent material like polycarbonate, that the plate-shaped converter element (20) at least at one side (14) is secured in a and is actuated by the deflector (D1) for torsion, and that an opto-electronic scanning device (T) is provided for the interior stress condition of the converter element, the scanning device (T) having an optical axis (21) penetrating the converter element (20) substantially perpendicular to the plate surfaces (17).

12. Thread detector as in claim 11, characterised in that wherein the opto-electronic detection device (T) includes a light source (15), preferably for generating isochromatic light or red light, polarisation elements (16, 18) at both sides of the converter element (20), the polarisation elements (16, 18) having respectively crossing polarisation axes, and a photo-element serving as a receiver (19).

13. Thread detector as in claim 1, characterised in that wherein a support (2) is provided in a base body (1), the support (2) having sockets (3) for the two converter assemblies (W), the sockets (3) being inclined to each other with an angle of about 90°, that two thread guides (8) are secured to the base body for defining the thread path, that both deflectors (D1, D2) protrudes protrude from the support (2) and extend crosswise through the thread path and cross each other with an angle smaller than 180°, preferably of about 90°, and that the support (2) has an inclined position relative to a plane (E) and about the thread axis, which inclined position is defined by the fictive stretched thread path between both thread guides (8) and the actual deflected thread path over both deflectors (D1, D2).

14. Thread detector as in claim 13, characterised in that wherein an adjustment device (22) for the inclined position of the thread detector (F) provided, preferably an adjustment device for the support (2) within the base body (1).
